(19) United States
(12) Patent Application Publication
(10) Pub. No.: US 2022/0336141 A1
(43) Pub. Date: Oct. 20, 2022

(54) TRANSFORMER

(71) Applicant: DELTA ELECTRONICS,INC., Taoyuan City (TW)

(72) Inventors: Chin-Hsin LAI, Taoyuan City (TW); Chien-Tung LU, Taoyuan City (TW); Sheng-Heng CHUNG, Taoyuan City (TW); Li-O LEE, Taoyuan City (TW); Chi-Kai LIN, Taoyuan City (TW); Ying-Chian KANG, Taoyuan City (TW); Yu-Chen HSIEH, Taoyuan City (TW); Chia-Kai WENG, Taoyuan City (TW)

(21) Appl. No.: 17/444,911

(22) Filed: Aug. 12, 2021

(30) Foreign Application Priority Data
Apr. 14, 2021 (CN) 202120759783.7

(51) Int. Cl. H01F 27/29; H01F 27/24; H01F 27/28

(52) U.S. Cl. CPC H01F 27/29; H01F 27/24; H01F 27/2823

(57) ABSTRACT

A transformer includes a drum core and a coil set wound on the drum core. The coil set includes a conductive member and an insulating layer wrapping around the conductive member. A diameter of the conductive member is between 0.07 mm and 0.2 mm, and a ratio of an outer diameter of the insulating layer to the diameter of the conductive member is between 1.35 and 2.5.

### RELATED APPLICATIONS

This application claims priority to China Application Serial Number 202120759783.7, filed Apr. 14, 2021, the disclosure of which is incorporated herein by reference in its entirety.

### BACKGROUND

### Technical Field

The present disclosure relates to a transformer.

### Description of Related Art

Power over Ethernet (PoE) is a technology that supplies power via Ethernet cable. PoE enables data and power transmission using only an Ethernet cable, eliminating the need to connect the device to other external power source. As technology advances, there is an increasing demand for bandwidth. However, current PoE transformer design has impedance matching problem at high frequency and thus cannot meet the spec of high bandwidth transmission (e.g., 10GBASE-T).

### SUMMARY

In view of the foregoing, one of the objects of the present disclosure is to provide a PoE transformer that can achieve high bandwidth at low loss.

To achieve the objective stated above, in accordance with an embodiment of the present disclosure, a transformer includes a first core, a primary side coil set and a secondary side coil set. The first core includes a first flange, a second flange, and a middle portion connected between the first flange and the second flange. The primary side coil set and the secondary side coil set are wound on the middle portion. The primary side coil set has two opposed ends connected to the first flange. The secondary side coil set has two opposed ends connected to the first flange or the second flange. The two opposed ends of the primary side coil set are connected to a first power source, and the two opposed ends of the secondary side coil set are connected to a second power source different from the first power source.

In accordance with an embodiment of the present disclosure, a transformer includes a first core, a primary side coil set and a secondary side coil set. The first core includes a first flange, a second flange, and a middle portion connected between the first flange and the second flange. The primary side coil set and the secondary side coil set are wound on the middle portion. The primary side coil set has two opposed ends and a middle end. The two opposed ends of the primary side coil set are connected to the first flange. The middle end of the primary side coil set is connected to the second flange. The secondary side coil set has two opposed ends connected to the first flange or the second flange. The two opposed ends of the primary side coil set are connected to a first power source, and the two opposed ends of the secondary side coil set are connected to a second power source different from the first power source.

In one or more embodiments of the present disclosure, the first power source is an AC power source or a DC power source, and the second power source is a DC power source.

In one or more embodiments of the present disclosure, the primary side coil set includes a first coil and a second coil. The first coil and the second coil each has an end connected to the first flange and another end connected to the second flange.

In one or more embodiments of the present disclosure, the another end of the first coil and the another end of the second coil are connected to the same conductive pad on the second flange.

In one or more embodiments of the present disclosure, the another end of the first coil and the another end of the second coil are connected different conductive pads on the second flange.

In one or more embodiments of the present disclosure, the secondary side coil set includes a third coil and a fourth coil. The third coil and the fourth coil each has an end connected to the first flange and another end connected to the second flange.

In one or more embodiments of the present disclosure, the transformer further includes a second core. The second core is connected to the first flange and the second flange.

In one or more embodiments of the present disclosure, the primary side coil set or the secondary side coil set includes a conductive member and an insulating layer wrapping around the conductive member.

In one or more embodiments of the present disclosure, a diameter of the conductive member is between 0.07 mm and 0.2 mm, and a ratio of an outer diameter of the insulating layer to the diameter of the conductive member is between 1.35 and 2.5.

In one or more embodiments of the present disclosure, the primary side coil set or the secondary side coil set has 7 to 14 turns.

In one or more embodiments of the present disclosure, the insulating layer includes polyurethane material, polyesterimide material, or polyamide composite material.

In accordance with an embodiment of the present disclosure, a transformer includes a drum core and a coil set wound on the drum core. The coil set includes a conductive member and an insulating layer wrapping around the conductive member. A diameter of the conductive member is between 0.07 mm and 0.2 mm, and a ratio of an outer diameter of the insulating layer to the diameter of the conductive member is between 1.35 and 2.5.

In one or more embodiments of the present disclosure, the coil set is a primary side coil set or a secondary side coil set.

In one or more embodiments of the present disclosure, the coil set has 7 to 14 turns.

In the present disclosure, at least one of the primary side coil set and the secondary side coil set of the transformer has a conductive member of diameter between 0.07 mm and 0.2 mm, and a ratio of an outer diameter of the insulating layer to the diameter of the conductive member is between 1.35 and 2.5. Said arrangement can tune the impedance of the coil suitably at high frequency, such that the transformer qualifies for high bandwidth transmission (e.g., 10GBASE-T).

### BRIEF DESCRIPTION OF THE DRAWINGS

To make the objectives, features, advantages, and embodiments of the present disclosure, including those mentioned above and others, more comprehensible, descriptions of the accompanying drawings are provided as follows.

FIG. 1 illustrates a perspective view of a transformer in accordance with an embodiment of the present disclosure;

FIG. 2 illustrates a bottom view of the transformer shown in FIG. 1;

FIG. 3 illustrates a cross-sectional view of the coil set of the transformer shown in FIG. 1;

FIG. 4 illustrates a diagram of loss plotted against bandwidth under various diameter ratios, when the conductive member of the coil set has a diameter of 0.1 mm and the insulating layer includes polyurethane material, wherein diameter ratio is defined as a ratio of an outer diameter of the insulating layer to the diameter of the conductive member;

FIG. 5 illustrates a diagram of loss plotted against bandwidth under various diameters of the conductive member, when the diameter ratio is 1.35 and the insulating layer includes polyurethane material;

FIG. 6 illustrates a bottom view of a transformer in accordance with another embodiment of the present disclosure; and

FIG. 7 illustrates a bottom view of a transformer in accordance with another embodiment of the present disclosure.

### DETAILED DESCRIPTION

For the completeness of the description of the present disclosure, reference is made to the accompanying drawings and the various embodiments described below. Various features in the drawings are not drawn to scale and are provided for illustration purposes only. To provide full understanding of the present disclosure, various practical details will be explained in the following descriptions. However, a person with an ordinary skill in relevant art should realize that the present disclosure can be implemented without one or more of the practical details. Therefore, the present disclosure is not to be limited by these details.

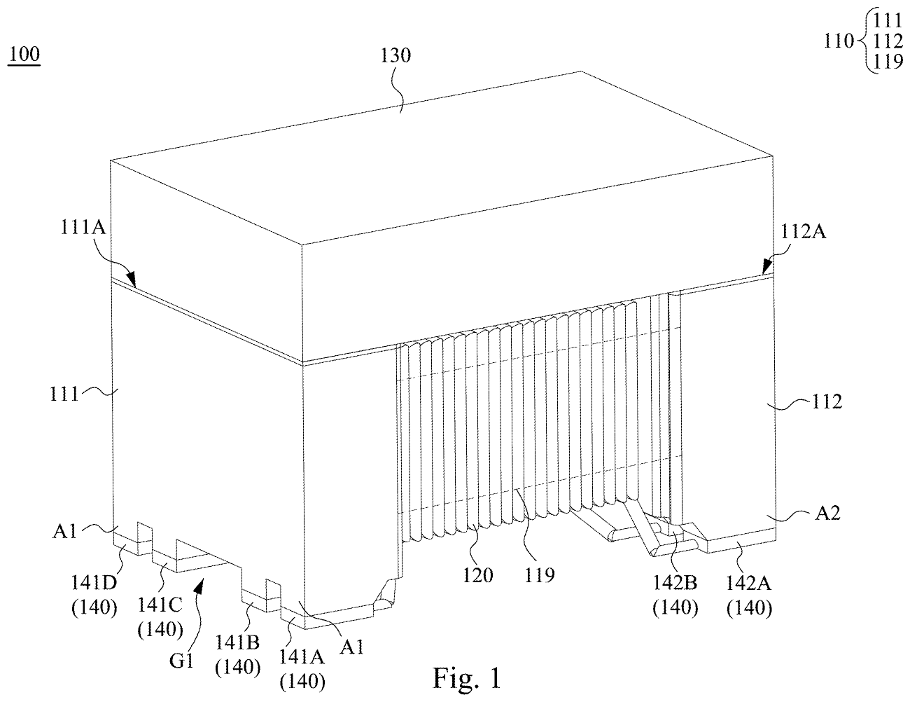

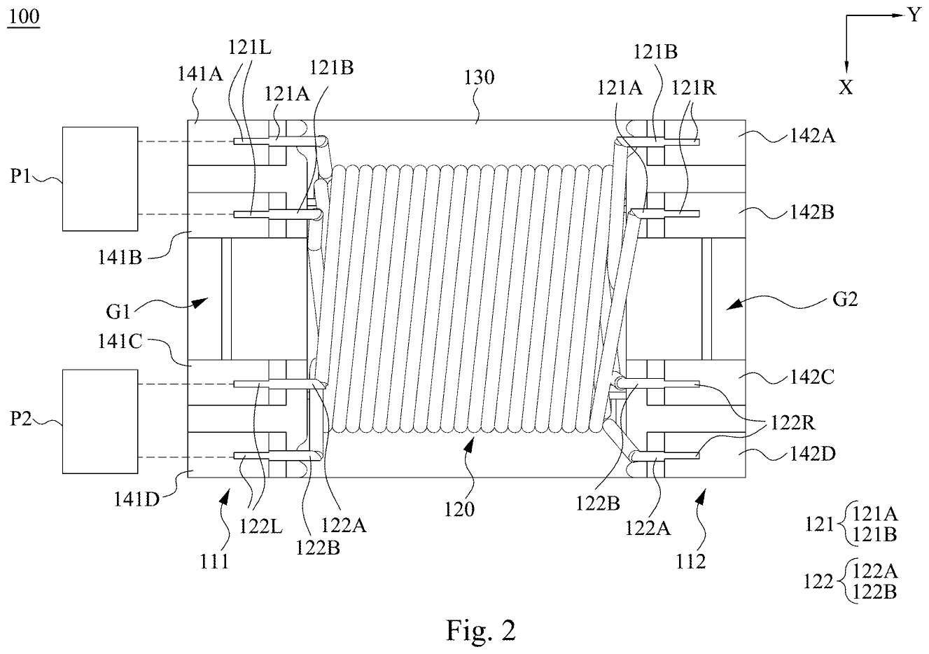

Reference is made to FIGS. 1 and 2. A transformer 100 (e.g., a PoE transformer, which may be integrated in an RJ-45 connector or be installed on a circuit board of a system) includes a first core 110 and a coil set 120 wound on the first core 110. The first core 110 is, for example, a drum core, and is made of magnetic material. The first core 110 includes a first flange 111, a second flange 112, and a middle portion 119 connected between the first flange 111 and the second flange 112. The coil set 120 includes a primary side coil set 121 and a secondary side coil set 122. The primary side coil set 121 is wound on the middle portion 119, and the primary side coil set 121 has two opposed ends and a middle end. The two opposed ends of the primary side coil set 121 are connected to the first flange 111. The middle end of the primary side coil set 121 is connected to the second flange 112. The secondary side coil set 122 is wound on the middle portion 119, and the secondary side coil set 122 has two opposed ends connected to the first flange 111.

As shown in FIGS. 1 and 2, in some embodiments, the primary side coil set 121 includes a first coil 121A and a second coil 121B. The first coil 121A and the second coil 121B each has a first end 121L and a second end 121R opposite to the first end 121L. The first end 121L is connected to the first flange 111, and the second end 121R is connected to the second flange 112. In such embodiments, the first ends 121L of the first and second coils 121A and 121B act as the two opposed ends of the primary side coil set 121, both of which are connected to the first flange 111, and the second ends 121R of the first and second coils 121A and 121B act as the middle end of the primary side coil set 121, which is connected to the second flange 112. In some embodiments, the first and second coils 121A and 121B may be formed by a single conductive wire. A middle section of the conductive wire may be connected to the second flange 112 to act as the middle end of the primary side coil set 121.

As shown in FIGS. 1 and 2, in some embodiments, the secondary side coil set 122 includes a third coil 122A and a fourth coil 122B. The third coil 122A and the fourth coil 122B each has a first end 122L and a second end 122R opposite to the first end 122L. The first end 122L is connected to the first flange 111, and the second end 122R is connected to the second flange 112. In such embodiments, the first ends 122L of the third and fourth coils 122A and 122B act as the two opposed ends of the secondary side coil set 122, both of which are connected to the first flange 111.

In some embodiments, the primary side coil set 121 and the secondary side coil set 122 are wound on the middle portion 119 of the first core 110 in one of the following ways: (1) two wires in parallel or twisted, such that the primary side coil set 121 and the secondary side coil set 122 form a double layer structure covering the middle portion 119; and (2) four wires in parallel or twisted, such that the primary side coil set 121 and the secondary side coil set 122 form a single layer structure covering the middle portion 119.

As shown in FIGS. 1 and 2, in some embodiments, the transformer 100 further includes a second core 130, which includes magnetic material. The second core 130 is connected to the first flange 111 and the second flange 112 of the first core 110, so as to form a closed magnetic path with the first core 110. In some embodiments, the second core 130 has two opposed ends which are fixedly attached to a top surface 111A of the first flange 111 and a top surface 112A of the second flange 112 respectively. The second core 130 may be I-shaped or plate-shaped.

The transformer 100 of the present disclosure is designed to be assembled from the first core 110 and the second core 130, making in suitable for automated production, which can save time and cost. In addition, the coil set 120 may be combined with the first core 110 by means of automated coil winding process, resulting in more predictable property and quality of the transformer 100.

As shown in FIGS. 1 and 2, in some embodiments, the transformer 100 further includes a plurality of conductive pads 140. The conductive pads 140 are disposed on the first core 110 and are configured to be connected with the coil set 120.

As shown in FIGS. 1 and 2, specifically, the conductive pads 140 include first conductive pads 141A, 141B, 141C and 141D. The first conductive pads 141A, 141B, 141C and 141D are disposed on a side of the first flange 111 away from the top surface 111A and are separated from one another. The first conductive pads 141A, 141B, 141C and 141D are arranged along a direction X, which is substantially perpendicular to a direction Y along which the middle portion 119 of the first core 110 extends. The first conductive pads 141A and 141B form a pair and are connected to the first ends 121L of the first and second coils 121A and 121B respectively. The first conductive pads 141C and 141D form a pair and are connected to the first ends 122L of the third and fourth coils 122A and 122B respectively.

As shown in FIGS. 1 and 2, in some embodiments, the two pairs of first conductive pads are separated by a gap G1. In the direction X, a width of the gap G1 is greater than a distance between the two conductive pads of either pair, i.e., the width of the gap G1 is greater than the distance between the first conductive pads 141A and 141B, and is greater than the distance between the first conductive pads 141C and 141D. In some embodiments, the first flange 111 has a plurality of protrusions A1 located on the side of the first flange 111 away from the top surface 111A. The first conductive pads 141A, 141B, 141C and 141D are disposed on the protrusions A1.

As shown in FIGS. 1 and 2, the conductive pads 140 further include second conductive pads 142A, 142B, 142C and 142D. The second conductive pads 142A, 142B, 142C and 142D are disposed on a side of the second flange 112 away from the top surface 112A and are separated from one another. The second conductive pads 142A, 142B, 142C and 142D are arranged along the direction X. The second conductive pads 142A and 142B form a pair and are connected to the second end 121R of the second coil 121B and the second end 121R of the first coil 121A, respectively. In other words, the second ends 121R of the first and second coils 121A and 121B are connected to different conductive pads on the second flange 112. The second conductive pads 142C and 142D form a pair and are connected to the second end 122R of the fourth coil 122B and the second end 122R of the third coil 122A, respectively.

As shown in FIGS. 1 and 2, in some embodiments, the two pairs of second conductive pads are separated by a gap G2. In the direction X, a width of the gap G2 is greater than a distance between the two conductive pads of either pair, i.e., the width of the gap G2 is greater than the distance between the second conductive pads 142A and 142B, and is greater than the distance between the second conductive pads 142C and 142D. In some embodiments, the second flange 112 has a plurality of protrusions A2 located on the side of the second flange 112 away from the top surface 112A. The second conductive pads 142A, 142B, 142C and 142D are disposed on the protrusions A2.

As shown in FIGS. 1 and 2, the two opposed ends of the primary side coil set 121 are connected to a first power source P1 at the first flange 111, and the two opposed ends of the secondary side coil set 122 are connected to a second power source P2 at the first flange 111, with the second power source P2 being different from the first power source P1. In some embodiments, the first power source P1 is an AC power source or a DC power source, and the second power source P2 is a DC power source.

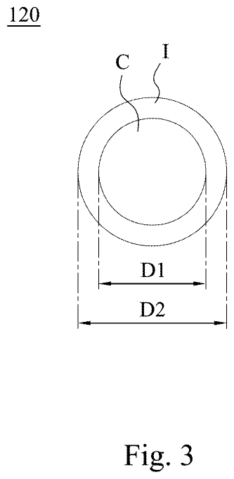

Reference is made to FIG. 3. The coil set 120 includes a conductive member C and an insulating layer I. The insulating layer I wraps around the conductive member C, i.e., the insulating layer I covers an outer surface of the conductive member C. In some embodiments, the conductive member C includes copper or other suitable conductive materials, and the insulating layer I includes polyurethane material, polyesterimide material, or polyamide composite material, other suitable insulating materials, or any combination thereof.

As shown in FIG. 3, the conductive member C of the coil set 120 has a disk-shaped cross section with diameter D1, which is between 0.07 mm and 0.2 mm. The insulating layer I of the coil set 120 has an outer diameter D2. Specifically, the insulating layer I has an inner surface contacting the conductive member C and an outer surface opposite to the inner surface. The outer diameter D2 of the insulating layer I refers to the diameter of the outer surface. A ratio of the outer diameter D2 of the insulating layer I to the diameter D1 of the conductive member C (i.e., D2 divided by D1) is between 1.35 and 2.5.

Said arrangement results in improved impedance property for the coil set 120 at high frequency, thus enabling the transformer 100 to be used for high bandwidth transmission (e.g., 10GBASE-T). Specifically, the transformer 100 of the present disclosure has the dimensions of its conductive member C and insulating layer I set in a suitable range to change the distributed capacitance between conductors, resulting in improved impedance property at high frequency.

In some embodiments, the secondary side coil set 122 has the aforementioned dimensions, i.e., the conductive member C of the third and fourth coils 122A and 122B has diameter which is between 0.07 mm and 0.2 mm, and a ratio of the outer diameter D2 of the insulating layer I of the third and fourth coils 122A and 122B to the diameter D1 of the conductive member C is between 1.35 and 2.5. In some embodiments, the primary side coil set 121 has the aforementioned dimensions, i.e., the conductive member C of the first and second coils 121A and 121B has diameter which is between 0.07 mm and 0.2 mm, and a ratio of the outer diameter D2 of the insulating layer I of the first and second coils 121A and 121B to the diameter D1 of the conductive member C is between 1.35 and 2.5. In some embodiments, both the secondary side coil set 122 and the primary side coil set 121 have the aforementioned dimensions.

In some embodiments, the coil set 120 has 7 to 14 turns, so as to obtain improved impedance property. Specifically, the number of turns of the coil set 120 refers to the number of times the coil set 120 goes around the middle portion 119 as the coil set 120 extends from the first flange 111 to the second flange 112. In some embodiments, the secondary side coil set 122 or the primary side coil set 121 has 7 to 14 turns, or both the secondary side coil set 122 and the primary side coil set 121 have 7 to 14 turns.

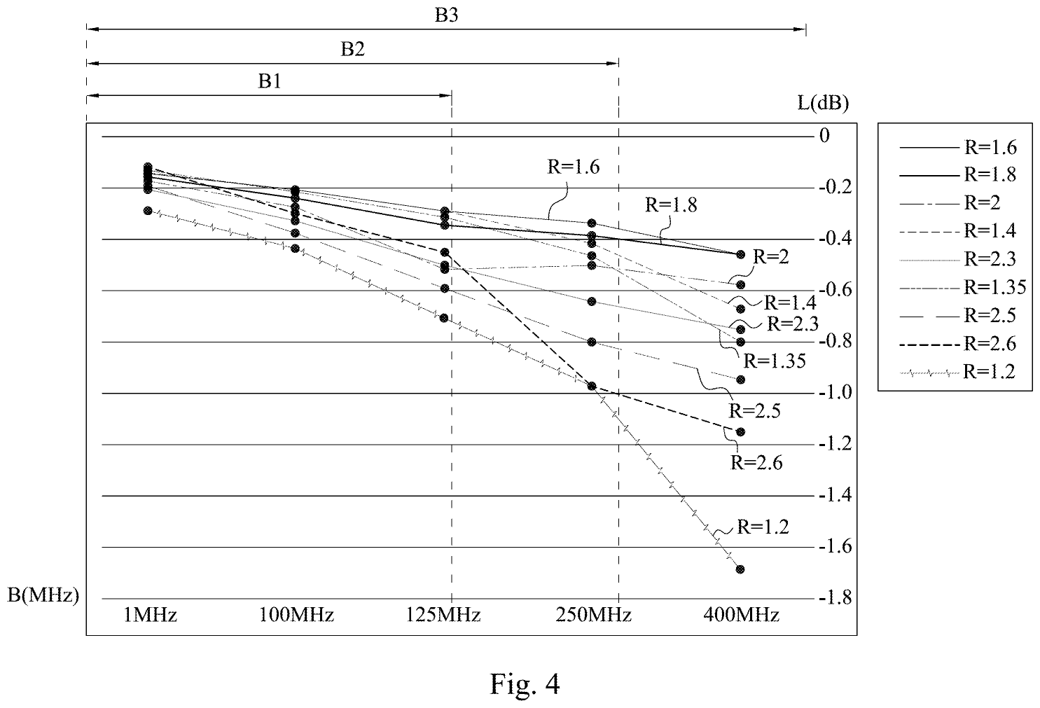

Reference is made to FIG. 4, which illustrates a diagram of loss L plotted against bandwidth B under various diameter ratios R, when the conductive member C of the coil set 120 has a diameter D1 of 0.1 mm and the insulating layer I includes polyurethane material. Diameter ratio R is defined as a ratio of the outer diameter D2 of the insulating layer I to the diameter D1 of the conductive member C (i.e., D2 divided by D1). The unit of loss L is dB, and the unit of bandwidth B is MHz.

FIG. 4 shows a first bandwidth design range B1 for 1G/2.5GBASE-T or lower standards, a second bandwidth design range B2 for 5GBASE-T standard, and a third bandwidth design range B3 for 10GBASE-T standard.

As shown in FIG. 4, when the diameter ratio R is between 1.35 and 2.5, the loss L can be successfully kept at or above the target value −1 over the entire third bandwidth design range B3. Accordingly, the transformer 100 can be used for 10GBASE-T high bandwidth transmission when the diameter ratio R of the coil set 120 is configured to be within the range from 1.35 to 2.5. Moreover, when the diameter ratio R is between 1.35 and 2.5, the loss L can be successfully kept at or above the target value −1 over the entire first and second bandwidth design ranges B1 and B2 as well. Therefore, compatibility with 5GBASE-T standard, or 1G/2.5GBASE-T or lower standards is maintained. On the other hand, when the diameter ratio R is below 1.35 or above 2.5 (e.g., when the diameter ratio R is 1.2 or 2.6), the loss L drops below −1 at the high frequency region. Therefore, such configuration is not suitable for 10GBASE-T standard.

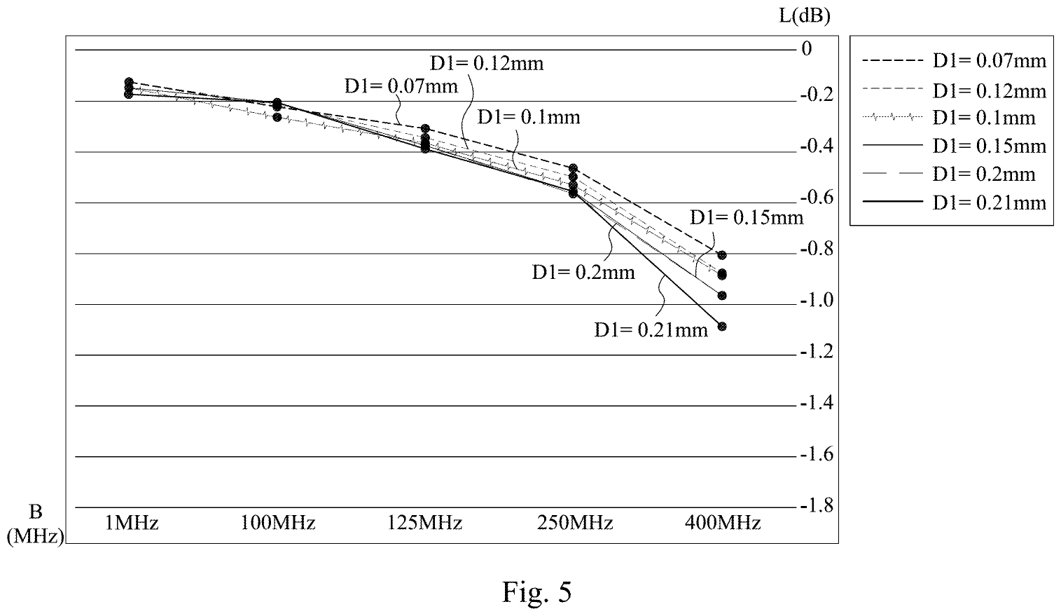

Reference is made to FIG. 5, which illustrates a diagram of loss L plotted against bandwidth B under various diameters D1 of the conductive member C, when the diameter ratio R is 1.35 and the insulating layer I includes polyurethane material. When the diameter D1 of the conductive member C is between 0.07 mm and 0.2 mm, the loss L can be successfully kept at or above the target value −1 over the entire third bandwidth design range B3. Accordingly, under such configuration, the transformer 100 can be used for 10GBASE-T high bandwidth transmission, and can also be compatible with 5GBASE-T standard, or 1G/2.5GBASE-T or lower standards. On the other hand, when the diameter D1 of the conductive member C is less than 0.07 mm or greater than 0.2 mm (e.g., when the diameter D1 is 0.21 mm), the loss L drops below −1 at the high frequency region. Therefore, such configuration is not suitable for 10GBASE-T standard.

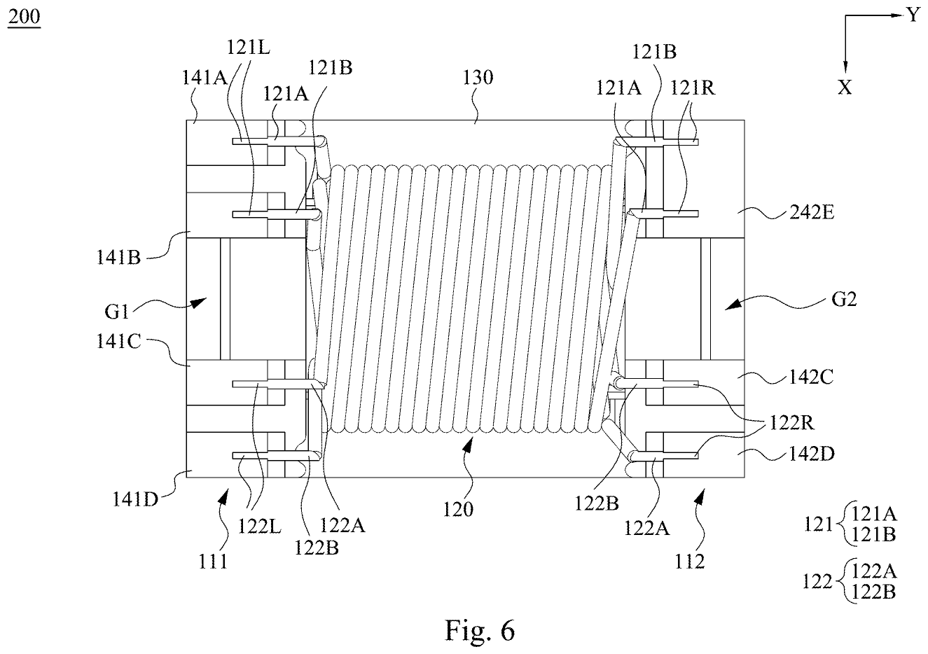

Reference is made to FIG. 6. Compared to the embodiments discussed above, the transformer 200 of the present embodiment includes a second conductive pad 242E disposed on the second flange 112 of the first core 110 to replace the second conductive pads 142A and 142B, and both the first coil 121A and the second coil 121B of the primary side coil set 121 have their second ends 121R connected to the second conductive pad 242E. In other words, the second ends 121R of the first and second coils 121A and 121B are connected to the same conductive pad on the second flange 112, and are thus electrically connected directly through the second conductive pad 242E.

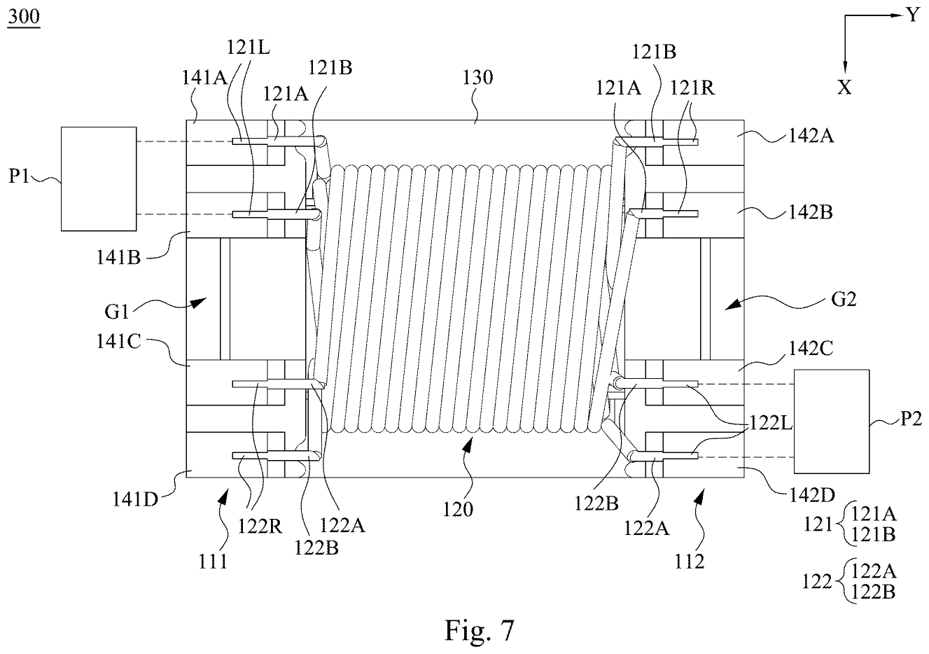

Reference is made to FIG. 7. The present embodiment differs from the embodiments discussed above in that the two opposed ends of the secondary side coil set 122 are connected to the second flange 112, and the two opposed ends of the secondary side coil set 122 are connected to the second power source P2 at the second flange 112, such that the first power source P1 and the second power source P2 are connected to different flanges of the first core 110. In some embodiments, the second power source P2 are electrically connected to the secondary side coil set 122 via the second conductive pads 142C and 142D. In some embodiments, the first ends 122L of the third and fourth coils 122A and 122B are connected to the second flange 112, and the second ends 122R of the third and fourth coils 122A and 122B are connected to the first flange 111. The first ends 122L of the third and fourth coils 122A act as the two opposed ends of the secondary side coil set 122, which are connected to the second flange 112 and are connected to the second power source P2 at the second flange 112.

In the present disclosure, at least one of the primary side coil set and the secondary side coil set of the transformer has a conductive member of diameter between 0.07 mm and 0.2 mm, and a ratio of an outer diameter of the insulating layer to the diameter of the conductive member is between 1.35 and 2.5. Said arrangement can tune the impedance of the coil suitably at high frequency, such that the transformer qualifies for high bandwidth transmission (e.g., 10GBASE-T).

Although the present disclosure has been described by way of the exemplary embodiments above, the present disclosure is not to be limited to those embodiments. Any person skilled in the art can make various changes and modifications without departing from the spirit and the scope of the present disclosure. Therefore, the protective scope of the present disclosure shall be the scope of the claims as attached.

What is claimed is:

1. A transformer, comprising:
a first core comprising a first flange, a second flange, and a middle portion connected between the first flange and the second flange;
a primary side coil set wound on the middle portion, wherein the primary side coil set has two opposed ends connected to the first flange; and
a secondary side coil set wound on the middle portion, wherein the secondary side coil set has two opposed ends connected to the first flange or the second flange;
wherein the two opposed ends of the primary side coil set are connected to a first power source, and the two opposed ends of the secondary side coil set are connected to a second power source different from the first power source.

2. The transformer of claim 1, wherein the first power source is an AC power source or a DC power source, and the second power source is a DC power source.

3. The transformer of claim 1, wherein the primary side coil set comprises a first coil and a second coil, the first coil and the second coil each has an end connected to the first flange and another end connected to the second flange.

4. The transformer of claim 1, wherein the secondary side coil set comprises a third coil and a fourth coil, the third coil and the fourth coil each has an end connected to the first flange and another end connected to the second flange.

5. The transformer of claim 1, further comprising a second core, wherein the second core is connected to the first flange and the second flange.

6. A transformer, comprising:
a first core comprising a first flange, a second flange, and a middle portion connected between the first flange and the second flange;
a primary side coil set wound on the middle portion, wherein the primary side coil set has two opposed ends and a middle end, the two opposed ends of the primary side coil set are connected to the first flange, and the middle end of the primary side coil set is connected to the second flange; and
a secondary side coil set wound on the middle portion, wherein the secondary side coil set has two opposed ends connected to the first flange or the second flange;
wherein the two opposed ends of the primary side coil set are connected to a first power source, and the two opposed ends of the secondary side coil set are connected to a second power source different from the first power source.

7. The transformer of claim 6, wherein the first power source is an AC power source or a DC power source, and the second power source is a DC power source.

8. The transformer of claim 6, the primary side coil set comprises a first coil and a second coil, the first coil and the second coil each has an end connected to the first flange and another end connected to the second flange.

9. The transformer of claim 8, wherein the another end of the first coil and the another end of the second coil are connected to the same conductive pad on the second flange.

10. The transformer of claim 8, wherein the another end of the first coil and the another end of the second coil are connected different conductive pads on the second flange.

11. The transformer of claim 6, wherein the secondary side coil set comprises a third coil and a fourth coil, the third coil and the fourth coil each has an end connected to the first flange and another end connected to the second flange.

12. The transformer of claim 6, further comprising a second core, wherein the second core is connected to the first flange and the second flange.

13. The transformer of claim 6, wherein the primary side coil set or the secondary side coil set comprises a conductive member and an insulating layer wrapping around the conductive member.

14. The transformer of claim 13, wherein a diameter of the conductive member is between 0.07 mm and 0.2 mm, and a ratio of an outer diameter of the insulating layer to the diameter of the conductive member is between 1.35 and 2.5.

15. The transformer of claim 13, wherein the primary side coil set or the secondary side coil set has 7 to 14 turns.

16. The transformer of claim 13, wherein the insulating layer comprises polyurethane material, polyesterimide material, or polyamide composite material.

17. A transformer, comprising:
a drum core; and
a coil set wound on the drum core, wherein the coil set comprises a conductive member and an insulating layer wrapping around the conductive member;
wherein a diameter of the conductive member is between 0.07 mm and 0.2 mm, and a ratio of an outer diameter of the insulating layer to the diameter of the conductive member is between 1.35 and 2.5.

18. The transformer of claim 17, wherein the coil set is a primary side coil set or a secondary side coil set.

19. The transformer of claim 17, wherein the coil set has 7 to 14 turns.

20. The transformer of claim 17, wherein the insulating layer comprises polyurethane material, polyesterimide material, or polyamide composite material.
